(19) United States
(12) Patent Application Publication
(10) Pub. No.: US 2016/0349928 A1
(43) Pub. Date: Dec. 1, 2016

(54) GENERATING SUMMARY OF ACTIVITY ON COMPUTER GUI

(71) Applicant: International Business Machines Corporation, Armonk, NY (US)

(72) Inventors: Linlin Li, Singapore (SG); Edwin B. Soenaryo, Singapore (SG)

(21) Appl. No.: 14/722,215

(22) Filed: May 27, 2015

(51) Int. Cl. G06F 3/0481; G06F 3/16; G06F 3/0488; G06K 9/18; G06F 3/0354; G06F 17/27; G06F 17/30; G06T 7/00; G06F 3/0489

(52) U.S. Cl. CPC G06F 3/0481; G06T 7/0085; G06T 7/004; G06F 3/167; G06F 3/04883; G06F 3/0489; G06F 3/03543; G06F 17/2735; G06F 17/30312; G06F 17/30864; G06F 17/3053; G06K 9/18

(57) ABSTRACT

Auditing activity of a user on a user computing device is provided. When the user computing device receives an input in a graphical user interface (GUI) from a human interface device (HID), an active window is identified within a captured screenshot by locating a screen location of the HID input in the GUI. The active window along with an extracted textual title of the active window, the screen location of the HID input and a user identifier are stored to a data store.

### BACKGROUND

The present invention relates generally to the field of monitoring user interactions with a graphical user interface, and more particularly to generating a summary of user actions performed in a monitored graphical window.

Enterprise-wide computer systems may require strict access control and monitoring. Organizations may require certain administrative activities undertaken by users on systems to be recorded for security and compliance purposes.

### SUMMARY

According to an embodiment of the invention, a method for auditing activity of a user on a user computing device is provided. The method receives a screenshot of a display device of the user computing device when the user computing device receives an input in a graphical user interface (GUI) from a human interface device (HID), and a screen location of the HID input, and a user identifier. The method identifies an active window in the received screenshot, based on the screen location of the HID input. The method extracts from the screenshot, the identified active window. The method determines a textual title of the active window. Finally, the method stores one or more electronic records that includes the extracted active window, the textual title of the active window, and the user identifier to a data store.

According to another embodiment of the invention, a computer program product for auditing activity of a user on a user computing device is provided. The computer program product includes one or more computer-readable storage media and program instructions stored on the one or more computer-readable storage media. The computer program product includes program instructions to receive a screenshot of a display device of the user computing device when the user computing device receives an input in a graphical user interface (GUI) from a human interface device (HID), and a screen location of the HID input, and a user identifier. It also includes program instructions to identify, by the computer, an active window in the received screenshot, based on the screen location of the HID input. It also includes program instructions to extract, by the computer, from the screenshot, the identified active window. It also includes program instructions to determine, by the computer, a textual title of the active window. Finally, it also includes additional program instructions to store one or more electronic records, by the computer, including the extracted active window, the textual title of the active window, and the user identifier to a data store.

According to another embodiment of the invention, a computer system for auditing activity of a user on a user computing device is provided. The computer system includes one or more computer processors, one or more computer-readable storage media, and program instructions stored on the computer-readable storage media for execution by at least one of the one or more processors. The computer system includes program instructions to receive, by a computer, a screenshot of a display device of the user computing device when the user computing device receives an input in a graphical user interface (GUI) from a human interface device (HID), and a screen location of the HID input, and a user identifier. The computer system includes program instructions to identify, by the computer, an active window in the received screenshot, based on the screen location of the HID input. The computer system also includes program instructions to extract, by the computer, from the screenshot, the identified active window. The computer system also includes program instructions to determine, by the computer, a textual title of the active window. Finally, the computer system also includes program instructions to store one or more electronic records, by the computer, including the extracted active window, the textual title of the active window, and the user identifier to a data store.

### BRIEF DESCRIPTION OF THE SEVERAL VIEWS OF THE DRAWINGS

FIG. 1 is a functional block diagram illustrating a system activity recording environment, in accordance with an embodiment of the present invention.

FIG. 2 is a functional block diagram illustrating a session recording agent, in accordance with an embodiment of the present invention.

FIG. 3 is a schematic block diagram illustrating a representative graphical user interface (GUI) display, in accordance with an embodiment of the present invention.

FIG. 4 is a flowchart depicting operational steps of the session recording agent, in accordance with an embodiment of the present invention.

FIG. 5 is a functional block diagram illustrating a session indexing and playback, in accordance with an embodiment of the present invention.

FIG. 6 is a schematic block diagram illustrating a representative screen display of a playback console of the session indexing and playback program, in accordance with an embodiment of the present invention.

FIG. 7 is a flowchart depicting operational steps of the session indexing and playback program, in accordance with an embodiment of the present invention.

FIG. 8 is a functional block diagram illustrating a cloud computing node according to an embodiment of the present invention.

FIG. 9 is a functional block diagram illustrating a cloud computing environment according to an embodiment of the present invention.

FIG. 10 is a functional block diagram illustrating abstraction model layers according to an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Typical client-side user activity recording systems may record user activity by continuously capturing screenshots. Some systems may simply record a user's entire session on a client system. Such recordings may require large amounts of storage, and record a large scope of activities. It may be advantageous for client-side recording systems to generate concise textual summaries of recorded user activities that occur within a graphical user interface. This may improve efficiency of, for example, compliance monitoring by replacing the need for a visual inspection of the recording of the entire session by a human. It may also be advantageous for the user activity summaries, or the session summaries, to include additional information, such as from where, what, by who, and when.

Embodiments of the present invention are generally directed to creating a summary of user actions performed in a monitored graphical window. Creating the summary may include recording user inputs and screenshots of the associated graphical window, generating a textual summary of each user input and the associated graphical window, and indexing and storing the summaries. In some embodiments, a user input monitoring system may have the ability to replay recorded user interactions.

The present invention will now be described in detail with reference to the figures. All brand names and/or trademarks used herein are the property of their respective owners.

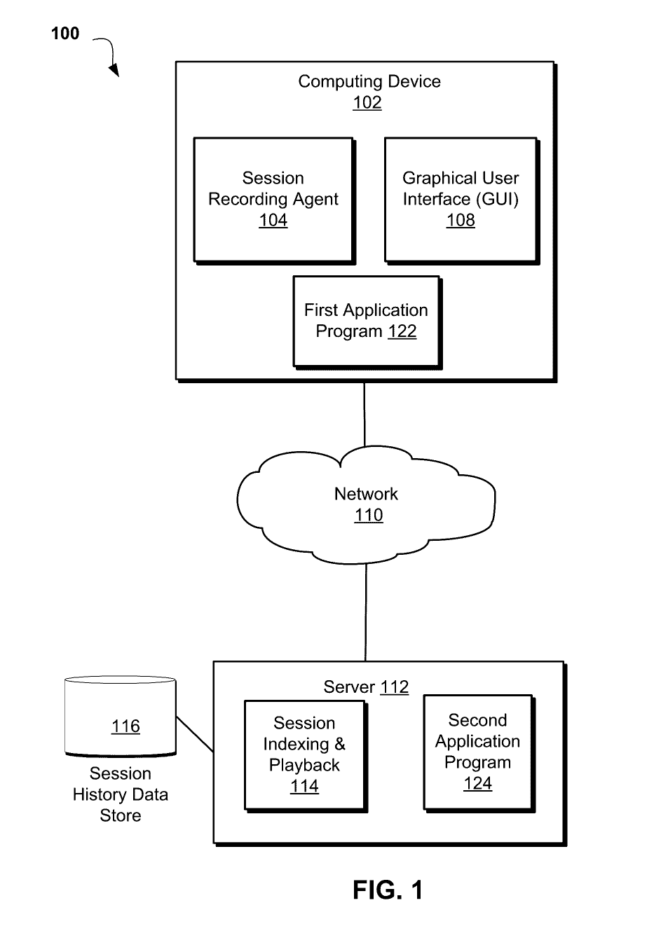

FIG. 1 is a functional block diagram illustrating an exemplary session recording environment 100 for developing user activity summaries of graphical session recordings. In various embodiments of the present invention session recording environment 100 may include a computing device 102 and a server 112, connected over network 110.

The network 110 represents a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Network 110 may also include a number of different types of networks, such as, for example, an intranet, a local area network (LAN), or a wide area network (WAN).

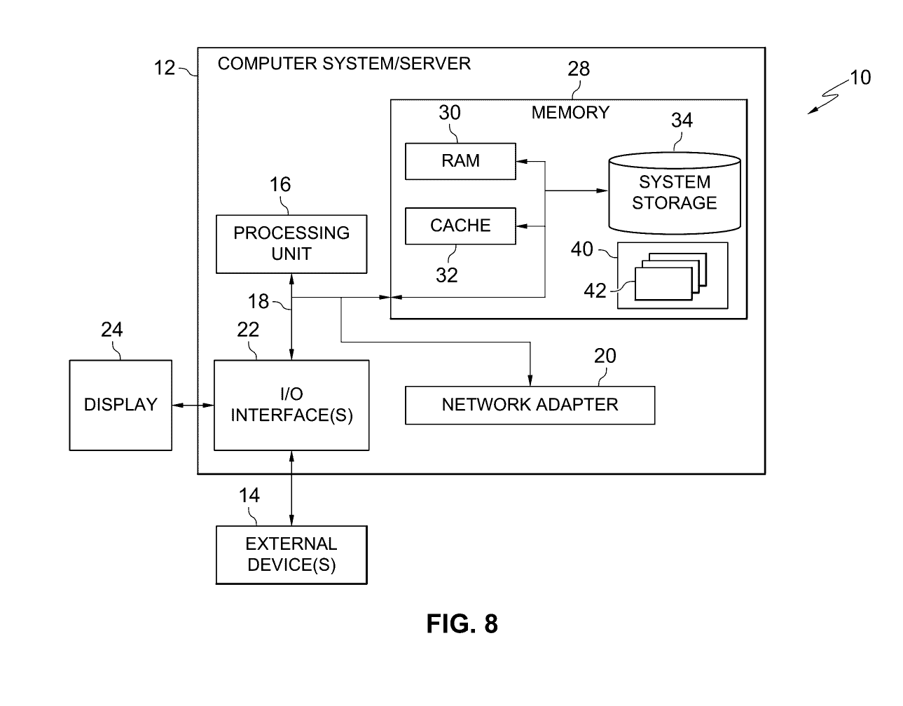

Computing device 102 represents a network connected user computing device on which user input will be monitored and recorded, in accordance with various embodiments of the invention. The computing device 102 may be, for example, a mobile device, a smart phone, a personal digital assistant, a netbook, a laptop computer, a tablet computer, a desktop computer, or any type of computing device capable of running a program and accessing a network, in accordance with one or more embodiments of the invention. In an embodiment, the computing device 102, and the server 112, which will be explained later, may form part of an enterprise system. Computing device 102 may include computer-readable storage media and other internal and external hardware components, as depicted and described in further detail below with reference to local computing devices 54A-N in a cloud computing environment, as described in relation to FIGS. 8, 9, and 10, below. In an embodiment, system components within computing device 102, for example, memory 28 and RAM 30 (FIG. 8), may include read-only registers and/or other data stores that contain device, network ID, user, active user program, system date/time, and other system and user information that may be accessible, for example, by application programming interfaces (APIs). Computing device 102 may also support screen capture, for example, by one or more proprietary or open source screen capture APIs.

In an embodiment, the computing device 102 may include a graphical user interface (GUI) 108, a first application program 122, and a session recording agent 104. GUI 108 represents an interface that accepts user input that will be monitored. In an exemplary embodiment, GUI 108 may be, for example, a web browser that accepts user input and interfaces with a network application, such as second application program 124 on server 112, both described in more detail below, or interfaces with a local application residing on computing device 102, such as first application program 122, described in more detail below. In other embodiments, GUI 108 may represent an interface that is integral to a local application residing on computing device 102, such as first application program 122. GUI 108 may accept user input from various human interface devices (HIDs) such as a computer mouse, a keyboard, a touchscreen, audio input, etc. In various embodiments, GUI 108 may support in-application screen capture, for example, by one or more proprietary or open source screen capture APIs or add-ons. In various embodiments, GUI 108 may support monitoring for user input, for example, by one or more proprietary or open source APIs or add-ons, so that an API or add-on may signal that user input has occurred.

First application program 122, as mentioned above, represents an application residing locally on computing device 102 that accepts user input via GUI 108. In an exemplary embodiment, first application program 122 represents an application that accepts user input and transmits associated information to a network platform via network 110. Because the associated information is transmitted off of computing device 102, it may be desirable to monitor user input to first application program 122 for security and compliance purposes. First application program 122 may be, for example, an email client, or a special purpose program related to a security or regulatory compliance requirement. As mentioned above, GUI 108 represents an interface by which first application program 122 accepts user input. GUI 108 may be a standalone interface to first application program 122, or may be an integral component of first application program 122.

Server 112 represents a network platform that hosts session indexing & playback 114, and optionally, second application program 124, and associated session history data store 116, described in more detail below. Server 112 may be, for example, a netbook, a laptop computer, a tablet computer, a desktop computer, or any type of computing device capable of running a program and accessing a network. Server 112 may include internal and external hardware components, as depicted and described in further detail below with reference to FIG. 8. In other embodiments, Server 112 may represent, for example, a network computing device such as devices 54A-N in a cloud computing environment, as described in relation to FIGS. 8, 9, and 10, below. In an embodiment, system components within server 112, for example, memory 28 and RAM 30 (FIG. 8), may include read-only registers.

Second application program 124 represents an application residing on a network server, such as server 112, which accepts user input via GUI 108. In an embodiment, second application program 124 represents an application that accepts user input via GUI 108 and transmits associated information to a network platform, such as server 112, via network 110. Similar to what was mentioned above, because the associated information may be transmitted off of computing device 102, it may be desirable to monitor user input to second application program 124 for security and compliance purposes. Second application program 124 may be, for example, an email server, or a special purpose program related to a security or regulatory compliance requirement. In an embodiment, GUI 108 may represent an interface by which second application program 124 accepts user input. GUI 108 may be a standalone interface to second application program 124, or may be an integral component of second application program 124.

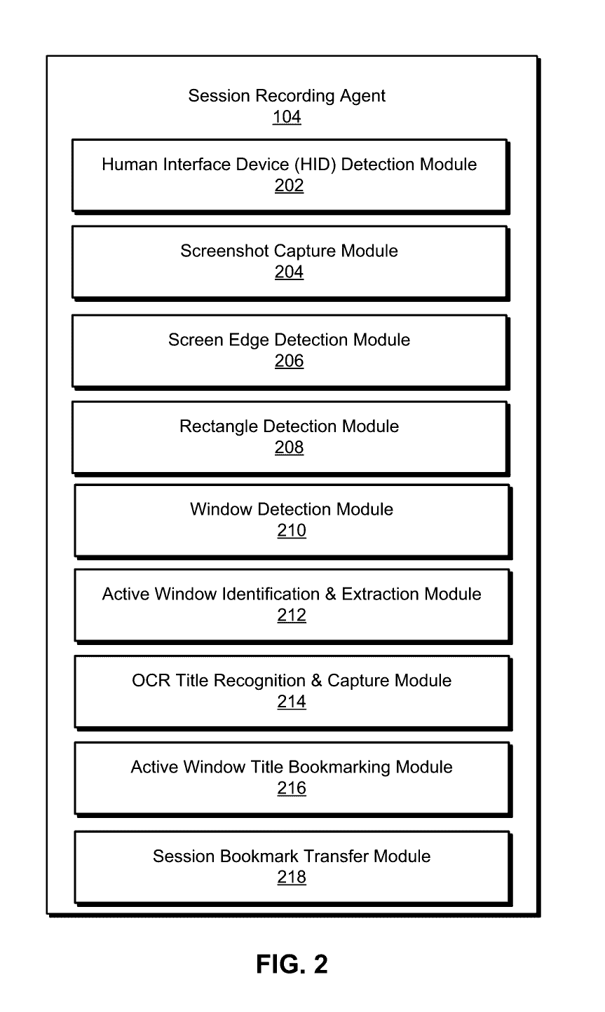

Session recording agent 104 operates to capture, bookmark, and transfer user interactions detected on GUI 108. FIG. 2 depicts modules that form part of session recording agent 104 of FIG. 1 in an embodiment. The modules may include: human interface device (HID) detection module 202, screenshot capture module 204, screen edge detection module 206, rectangle detection module 208, window detection module 210, active window identification & extraction module 212, OCR title recognition & capture module 214, active window title bookmarking module 216, and session bookmark transfer module 218.

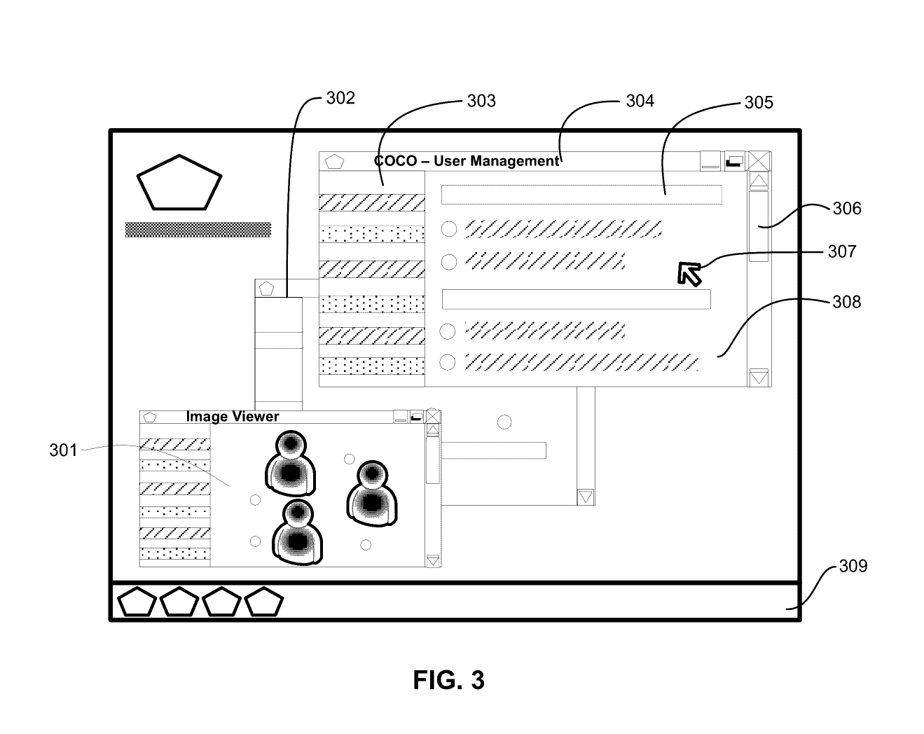

FIG. 3 depicts a schematic block diagram of a representative GUI display of GUI 108 on computing device 102 (FIG. 1), in which various embodiments of the present invention may be implemented. In FIG. 3, one or more of the windows such as, for example, window 301, window 302, and window 308, may be opened on GUI 108 as detected by session recording agent 104. In an exemplary embodiment, windows 301, 302, and 308 may constitute graphical displays of first application program 122 (FIG. 1). GUI 108 display may receive a HID input from a HID such as a computer mouse that a user may use to interact with the GUI display of first application program 122.

FIG. 3, in conjunction with FIG. 2, may be used to describe operations of session recording agent 104 in various embodiments. Referring now to FIGS. 2 and 3, in various embodiments, session recording agent 104 may automatically initiate as soon as HID detection module 202 detects an input by a HID on GUI 108 (FIG. 3), and commence services associated with capture and archiving of a summary of a user's interactions detected on GUI 108. In an exemplary embodiment, a HID detection module 202 of session recording agent 104 may detect a click by a mouse pointer 307 on an area covered by window 308 on GUI 108 (FIG. 3). It should be noted that, in various embodiments, besides a computer mouse, a HID may also include a display/touch screen, a navigation key-set, application keys and softkeys. In an embodiment, HID detection module 202 may utilize one or more proprietary or open source APIs to detect that a HID input has occurred on GUI 108. After detecting the HID input, HID detection module 202 may record the location of the HID input, the mouse click.

Screenshot capture module 204 may then capture a screenshot of GUI 108, using, for example, a function similar to one which is initiated when Ctrl+Print Screen keys on a keyboard are pressed simultaneously in a window environment, at an instant when the mouse click is detected by HID detection module 202. Screen edge detection module 206 may then identify edges of one or more rectangles that may be present within the received captured screenshot using basic edge detection technics well known in the art. The identified edges may include two parallel horizontal lines and two parallel vertical lines, with a basic edge detection operator calculating x-axis and y-axis derivatives. Basic edge detection operators may be preferred over multi-stage edge detection operators because the latter may typically be slower to detect edges and they may also tend to be inaccurate in their ability to identify borders. Rectangle detection module 208 may then identify one or more rectangles corresponding to the identified edges using a suitable technique such as, for example, a windowed Rectangular Hough Transform (RHT) method, whereby every pixel of a captured image may be scanned. Then a sliding window may be used to compute the Hough Transform of small regions of the image. Peaks of the Hough image, which correspond to line segments, may then be extracted, and a rectangle identified when four extracted peaks satisfy certain geometric conditions. By way of a non-limiting example, in FIG. 3, rectangle detection module 208 may identify 301, 302, 303, 304, 305, 306, 308, and 309, among others, as rectangles. It should be noted that not all of the identified rectangles may be actual windows.

Window detection module 210 may then attempt to identify one or more windows corresponding to the identified rectangles. In an embodiment, a unique and consistent pattern of a window in an operating system may be the presence of a standard set of three control buttons—minimize, maximize and close. The presence, sequence, orientation, and appearance of these three control buttons may be uniform for a given operating system. With standard pattern matching techniques, it may be relatively straightforward for window detection module 210 to locate the control button sets in the screenshot captured by screenshot capture module 204. In order to prevent the effect of subsequent changes in an operating system's theme and font size on the ability of window detection module 210 to locate the control button sets, a suitable affine invariant descriptor that detects features that are invariant to image scaling, translation, and rotation, and partially invariant to illumination changes and affine or 3D projection may be utilized. In an exemplary embodiment, window detection module 210 may identify rectangles 301, 302, and 308 in FIG. 3 as windows.

Following this, active window identification & extraction module 212 may detect and extract one of the windows identified by window detection module 210 as an active window, using a suitable function such as, for example, the focus function initiated when the shift+tab keys are simultaneously pressed on a keyboard in a window environment. In an exemplary embodiment, active window identification & extraction module 212 may use the mouse click, an output from HID detection module 202, and identified windows 301, 302, and 308 (FIG. 3), outputs of window detection module 210, to identify rectangle 308 as an active window and digitally extract the active window. In identifying and extracting the active window, active window identification & extraction module 212 may expand its focus from a particular location represented by the location of a click of the mouse pointer 307 (FIG. 3), applying image processing techniques on a gradually increasing rectangular focus area, up to a certain threshold, centered on the point of the mouse click to detect and extract the whole area of the active window. In an embodiment, active window identification & extraction module 212 apply image processing techniques on a gradually increasing rectangular focus area, up to a certain threshold, centered on the point of the mouse click to detect a window control that the click of the mouse pointer 307 may have activated. Active window identification & extraction module 212 may also read a label of the window control that was activated by applying OCR techniques.

It should be noted that if active window identification & extraction module 212 is unable to detect an active window, it may terminate at that point and may re-initiate only when an active window is again detected. Similarly, session recording agent 104 may also terminate at other decision points such as: screen edge detection module 206 unable to detect at least four screen edges; rectangle detection module 208 unable to detect a rectangle; window detection module 210 unable to detect a window; and active window identification & extraction module 212 unable to detect an active window.

OCR title recognition & capture module 214 may then process an output of active window identification & extraction module 212 to develop a title of the active window using a suitable OCR technique well known in the art to recognize characters that may be present in a general region of a title bar within a digital image of the active window, and generate an editable text corresponding to the title of the active window. OCR title recognition & capture module 214 may also determine any subsequent changes to the window title by performing periodic optical character recognition of the title bar of the active window, and comparing any newly detected text to a previously recognized window title text. In an exemplary embodiment, OCR title recognition & capture module 214 may capture the words “COCO—User Management” found on the title bar of active window 308 (FIG. 3) using OCR techniques as the title of the active window 308. Active window title bookmarking module 216 may then store the OCR title, the identified active window, along with other identification features such as device ID, network ID, user ID, active user program identification, raw HID inputs, labels of window controls activated by the raw HID inputs, date/time stamp, and other system and user information available from the system components within computing device 102, as a session bookmark. The session bookmark's value may be set to the title of the active window as identified by the OCR title recognition & capture module 214, and its reference may be set to the active window identified by the active window identification & extraction module 212. Each of such successive session bookmarks may also be respectively attributed with a time stamp to indicate when an active window is captured, in addition to the other identifying features. In an embodiment, prior to active window title bookmarking module 216 completing generation of the session bookmark, the captured active windows in digital image format present in the session bookmark files may be compressed using a commonly known image compression technique such as JPEG. In another embodiment, the captured active window digital images may be compressed using a commonly known image compression technique such as MPEG to take the advantage of similarity between two immediate active window images. One purpose of such compression techniques may be to reduce the data size to increase efficiency when the session bookmark may be transferred over the network 110 (FIG. 1). The session bookmark transfer module 218 may then transfer the session bookmark over to session indexing & playback 114 (FIG. 1), to be described below. In an embodiment, the process cycle of the session recording agent 104 may conclude at this juncture. It is clear to those skilled in the art that not every element in session recording agent 104 may need to be implemented to achieve the desired results contemplated by the present invention.

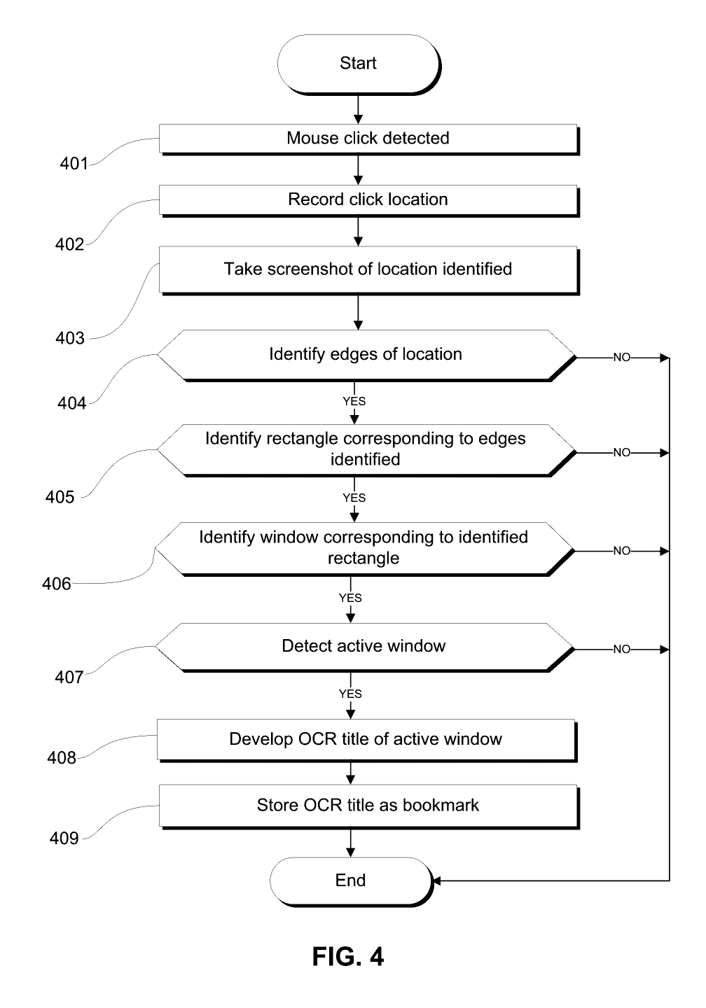

FIG. 4 is a flowchart depicting operational steps of session recording agent 104, in accordance with an embodiment of the present invention. Steps depicted in FIG. 4 may be implemented using one or more modules of a computer program, for example, session recording agent 104, and executed by a processor of a computer such as computing device 102. HID detection module 202 of session recording agent 104 may initiate as soon as it detects a mouse click on GUI 108 (step 401), and may record the location of the mouse click (step 402). Screenshot capture module 204 may then capture a screenshot of GUI 108 (step 403). Screen edge detection module 206 may then locate edges of the identified location (step 404). Rectangle detection module 208 may then identify a rectangle corresponding to the identified edges (step 405). Window detection module 210 may then identify one or more windows corresponding to the identified rectangles (step 406). Active window identification & extraction module 212 may then detect one of the windows identified in step 406 as an active window (step 407). OCR title recognition & capture module 214 may then develop a title of the active window in editable text format using a suitable OCR technique (step 408). Active window title bookmarking module 216 may then store the OCR title, the identified active window, along with other identification within computing device 102 (step 409). If session recording agent 104 is unable to detect an active window at step 407, it terminates at that point until an active window is again detected. Similarly, session recording agent 104 may terminate at other decision points such as: screen edge detection module 206 unable to detect at least four screen edges (step 404), rectangle detection module 208 unable to detect a rectangle (step 405), and window detection module 210 unable to detect a window (step 406).

Returning to FIG. 1, session indexing & playback 114 operates to index, summarize, archive, and playback summaries of user interactions detected on GUI 108 and processed by session recording agent 104. Session indexing & playback 114 may also operate to retrieve and playback archived session activity summary recordings based on a submitted query, in accordance with various embodiments of the present invention. Session indexing & playback 114 may also operate to manage and utilize session history data store 116, to be described later.

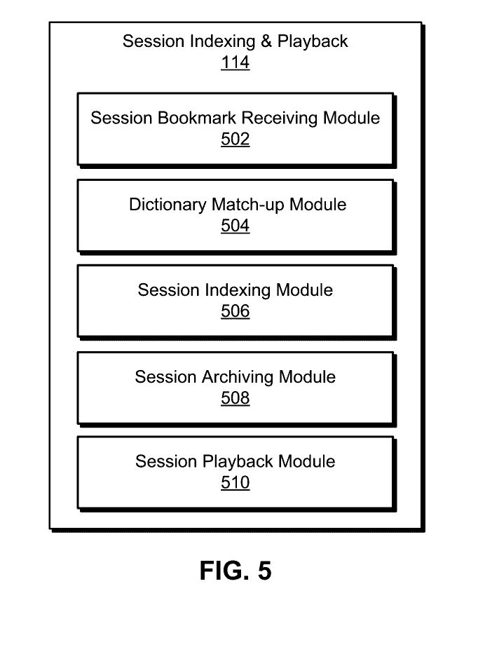

FIG. 5 is a functional block diagram illustrating session indexing & playback 114, in accordance with an embodiment of the present invention. FIG. 5 displays modules that may form part of session indexing & playback 114 in an embodiment. In an exemplary embodiment, session indexing & playback 114 may reside and execute on server 112 (FIG. 1) and may include the following modules: session bookmark receiving module 502, dictionary match-up module 504, session indexing module 506, session archiving module 508, and session playback module 510.

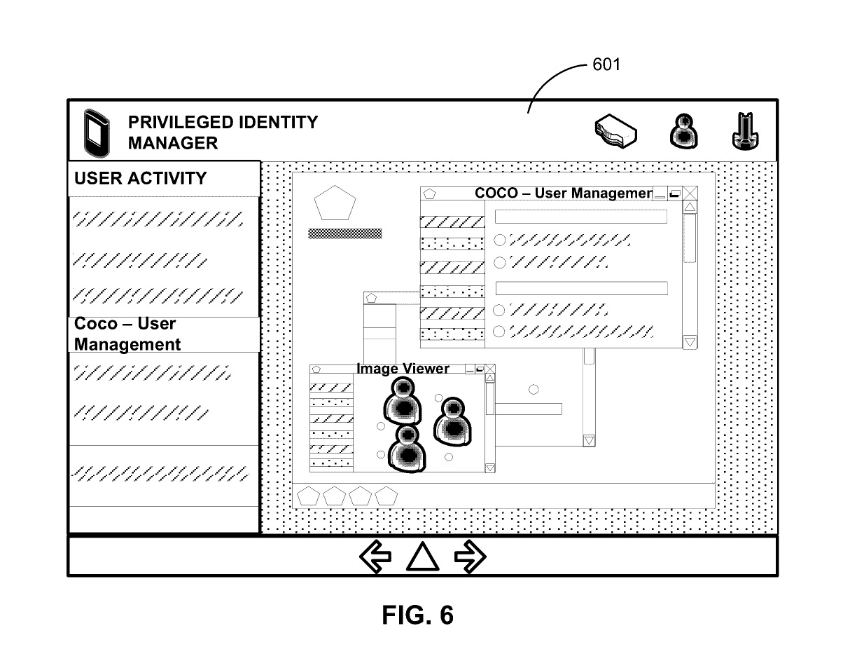

FIG. 6 depicts a schematic block diagram of a representative GUI display of playback console 601, in one embodiment of the present invention. In various embodiments of the present invention, playback console 601 represents a GUI display component of session indexing & playback 114, and playback console 601 may be viewable on a computer screen of a computing device, such as, for example, server 112. Playback console 601 may represents a tool that interacts with session indexing & playback 114 to call up an archived session activity summary recording.

FIG. 6, in conjunction with FIG. 5, may be used to illustrate operations of session indexing & playback 114 in an embodiment. Referring now to FIGS. 5 and 6, in various embodiments, session bookmark receiving module 502 of session indexing & playback 114 may await for a session bookmark from session bookmark transfer module 218 of session recording agent 104 to arrive. In an embodiment, session bookmark receiving module 502 may receive session bookmarks, or processed versions thereof, at regular pre-determined intervals through network 110 from session bookmark transfer module 218 (FIG. 2) of session recording agent 104 (FIG. 1). Session bookmark files may arrive either as multiple files, each coming individually for one transaction, or as a single compounded file containing several bookmarks, depending on which option may be better suited to optimize the available memory, processing, and network resources.

It should be noted that, in various embodiments, in instances where session bookmark transfer module 218 (FIG. 2) is unable to transfer session bookmarks to session bookmark receiving module 502 due to, for example, temporary inaccessibility to the network 110, session recording agent 104 (FIG. 1) may temporarily store the generated session bookmarks in a local memory store until accessibility to network 110 is re-established.

Once session bookmark receiving module 502 receives a session bookmark, or versions thereof, dictionary match-up module 504 may match-up the received session bookmark with an internal dictionary. Dictionary match-up module 504 may contain translations of known window titles of computer applications commonly accessed through computing device 102 in multiple languages, and may substitute a window title that matches an entry in the dictionary with the corresponding key. In an exemplary embodiment, in FIG. 3, a bookmark value of “Coco—User Management” may be stored as “Coco—{usermgr.defaultTitle},” the dictionary key corresponding to the captured bookmark value. In another embodiment where the window titles may be in French, a bookmark value of “Coco—Gestion des Utilisateurs” may be stored as “Coco—{usermgr.defaultTitle},” the dictionary key corresponding to the captured French bookmark value.

Session indexing module 506 may then proceed to develop a session activity summary recording based on the received session bookmark and index the same. In an embodiment, session indexing module 506 may supplement or complement the services provided by active window title bookmarking module 216 (FIG. 2) in reducing the data size of the received session bookmark before generating the session activity summary recording. The indexing functionality of session indexing module 506 may be quite complex, and incorporate interdisciplinary concepts from linguistics, cognitive psychology, mathematics, informatics, physics, and computer science. In various embodiments, the indexing functionality may focus on a more traditional full-text indexing of natural language content in the received session bookmarks. As part of the indexing process, session indexing module 506 may assign an identification to the generated session activity summary recording so that it may be queried later during audits. In an embodiment, the identification may include a session identifier, a user identifier, a system identifier, a textual title of a captured active window, an application identifier, and a server identifier. In an exemplary embodiment, in FIG. 3, session indexing module 506 may index the generated session activity summary recording with the title “Coco—{usermgr.defaultTitle}.

Session archiving module 508 may then archive session activity summary recording along with session identifiers, as well as all captured text and extracted text. A collection of all consecutively captured active windows and their corresponding titles and other processed data from one instance of user session on computing device 102, commencing at an instant when the user logs on into computing device 102 and concluding when the user is subsequently logged off computing device 102, may constitute one unit of session activity summary recording. In various embodiments, session archiving module 508 may archive the unit of session activity summary recording in session history data store 116 (FIG. 1). Session archiving module 508 may store several such indexed electronic records in session history data store 116. In various embodiments, session history data store 116 may represent a network storage device capable of storing data in a structured or unstructured format. Session history data store 116 may represent a single storage device or a cluster of storage devices. The data stored in the session history data store 116 may be data of any type.

Later, during an auditing that may be conducted by a system administrator, in an embodiment, session playback module 510, which may include playback console 601 as a component, may receive a query from the system administrator to display an archived session activity summary recording. The query may come from any computer terminal operated by any operator, according to various embodiments of the invention. The query may include parameters related to a transaction ID or user identifier information so that a correct session activity summary recording associated with the received query may be retrieved from the archives. For example, in an embodiment, session playback module 510 may receive a query via playback console 601 to display a history of a user's actions with respect to a certain web site. Session playback module 510 may then proceed to look up within session history data store 116 for an archived session activity summary recording unit corresponding to the submitted query. Prior to proceeding with the look up, the search query may be parsed in a manner complimentary to the indexing function of session indexing module 506 to ensure that the search terms from the processed query may effectively align with the index previously created by session indexing module 506. If applicable, a query may be subjected to a substitution by dictionary match-up module 504 before being delegated for look up processing. In an exemplary embodiment, session indexing module 506 may replace a received search query value of “Coco—User Management” with the value “Coco—{usermgr.defaultTitle}, prior to proceeding to look up a corresponding archived session activity summary recording unit within session history data store 116. After the text based search terms have been parsed from the search query as needed, session playback module 510 may execute a search of the index, rank the results that may be stored in html format, and return the ranked results in the form of formatted URLs to the playback console 601. When the operator clicks on a certain URL, playback console 601 may playback the recorded information associated with the selected session activity summary recording unit archive. Typically, the system administrator may be permitted to retrieve any user's archived session activity summary recording. It is clear to those skilled in the art that not every element in session indexing & playback 114 needs to be implemented to achieve the desired results contemplated by the present invention.

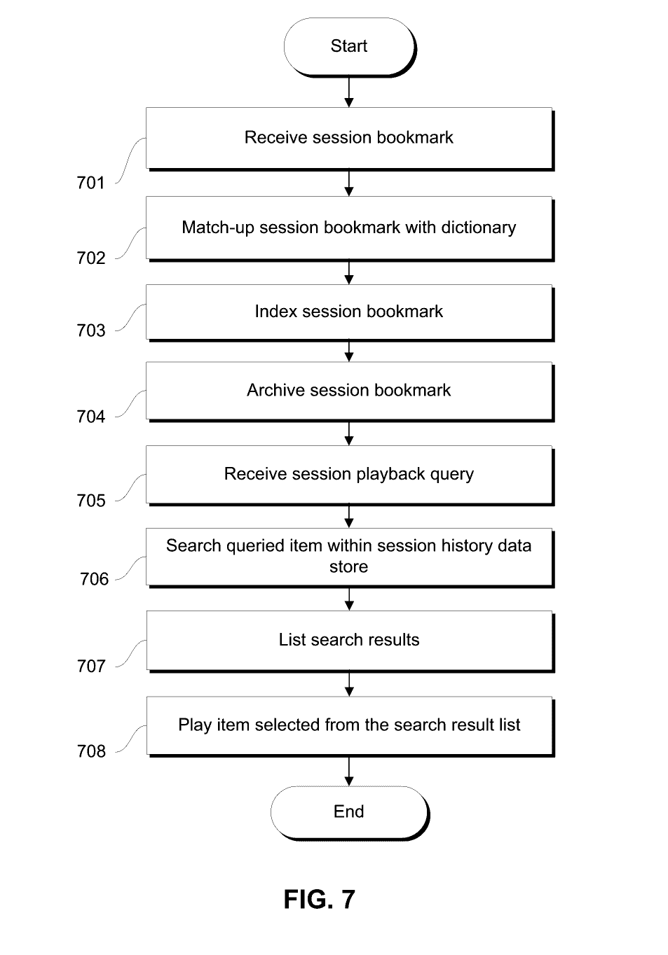

FIG. 7 is a flowchart depicting operational steps of the session indexing & playback 114, in accordance with an embodiment of the present invention. Steps shown in FIG. 7 may be implemented using one or more modules of a computer program, for example, session indexing & playback 114, and executed by a processor of a computer, such as server 112. Session bookmark receiving module 502 (FIG. 5) of session indexing & playback 114 (FIG. 1) may receive a session bookmark from session bookmark transfer module 218 (FIG. 2) of session recording agent 104 (FIG. 1) (step 701). Dictionary match-up module 504 may then match-up the session bookmark with an internal dictionary (step 702). Then, session indexing module 506 may proceed to develop a session activity summary recording based on the received session bookmark and index it (step 703). Session archiving module 508 may then archive session activity summary recording along with session identifiers, as well as all captured text and extracted text (step 704).

Session playback module 510 may receive a query via playback console 601 (FIG. 6) to display a history of a user's actions with respect to a certain web site (step 705). Session playback module 510 may proceed to look up within session history data store 116 for an archived session activity summary recording unit corresponding to the submitted query (step 706). Session playback module 510 may return results from the lookup in the form of formatted URLs to the playback console 601 (step 707). When the operator clicks on a certain URL, playback console 601 may playback the recorded information associated with the selected bookmarked item (step 708).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 8, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

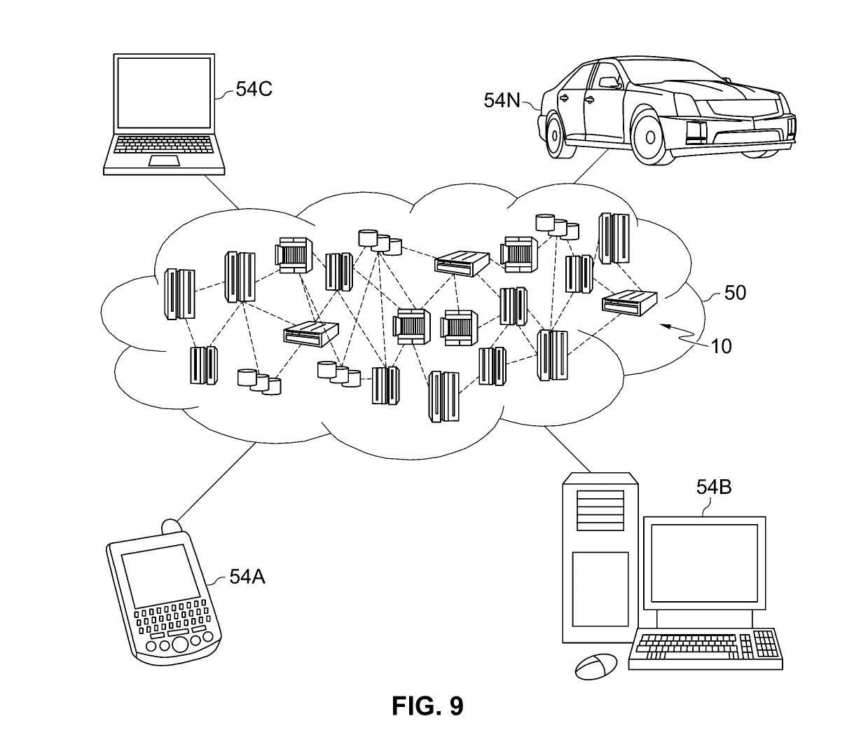

Referring now to FIG. 9, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

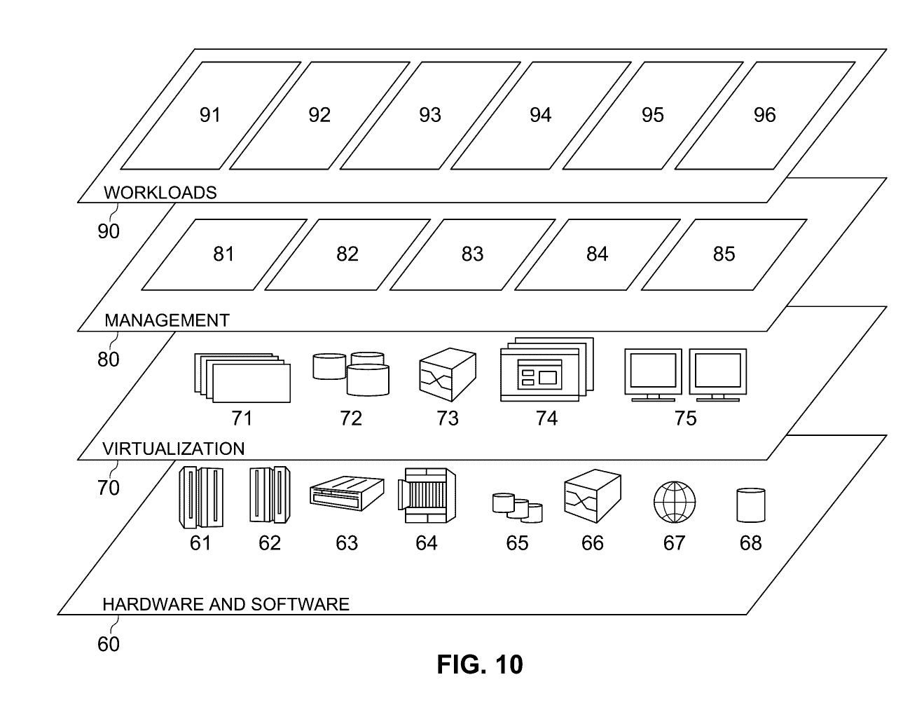

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, session recording agent and session indexing & playback programs 96.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The many features and advantages of the present invention are apparent from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be considered to fall within the scope of the invention.

What is claimed is:

1. A method for auditing activity of a user on a user computing device, the method comprising:
receiving, by a computer, a screenshot of a display device of the user computing device when the user computing device receives an input in a graphical user interface (GUI) from a human interface device (HID), and a screen location of the HID input, and a user identifier;
identifying, by the computer, an active window in the received screenshot, based on the screen location of the HID input;
extracting, by the computer, from the screenshot, the identified active window;
determining, by the computer, a textual title of the active window; and
storing one or more electronic records, by the computer, comprising the extracted active window, the textual title of the active window, and the user identifier to a data store.

2. A method according to claim 1, wherein identifying the active window comprises:
locating edges of one or more rectangles present in the received screenshot;
identifying one or more rectangles corresponding to the located edges;
detecting one or more windows corresponding to the identified rectangles; and
identifying the active window based on the screen location of the HID input within the detected one or more windows.

3. A method according to claim 1, wherein determining the textual title of the active window comprises:
recognizing characters in a general region of a title bar of the active window using an object character recognition (OCR) technique; and
extracting the characters to develop the textual title of the active window.

4. A method according to claim 1, wherein the HID includes one or more of: a computer mouse, a keyboard, a touchscreen, and an audio input.

5. A method according to claim 1,
wherein receiving a screenshot of a display device further comprises receiving one or more of: a device identifier, a network identifier, an active user program identifier, raw HID inputs, and a date/time stamp; and
wherein the storing one or more electronic records further comprises storing one or more of: the device identifier, the network identifier, the active user program identifier, the raw HID inputs, and the date/time stamp.

6. A method according to claim 1, furthering comprising:
replacing the textual title of the active window with an internal dictionary key.

7. A method according to claim 1, wherein storing the one or more electronic records further comprises:
indexing the textual title of the active window to enable querying by the computer in a GUI environment.

8. A method according to claim 1, further comprising:
retrieving the extracted active window, the textual title of the active window and the user identifier from the data store; and
displaying the extracted active window, the textual title of the active window and the user identifier on a display device of the computer.

9. A method according to claim 1, wherein steps of the method are performed using a set of instructions of a program, wherein the program is an application executed on one or more of:
a cloud computing environment;
a mobile device; and
a desktop device.

10. A method according to claim 1, further comprising:
loading, by the computer, the one or more electronic records; and
displaying, by the computer on a display device of the computer, the loaded one or more electronic records including one or more of:
the extracted active window;
the textual title of the active window; and
the user identifier.

11. A method according to claim 1, further comprising:
searching, by the computer, an index of the one or more electronic records based on a query;
ranking results of the searching; and
displaying the results according to the ranking.

12. A computer program product for auditing activity of a user on a user computing device, the computer program product comprising:
one or more computer-readable storage media and program instructions stored on the one or more computer-readable storage media, the program instructions comprising:
program instructions to receive, by a computer, a screenshot of a display device of the user computing device when the user computing device receives an input in a graphical user interface (GUI) from a human interface device (HID), and a screen location of the HID input, and a user identifier;
program instructions to identify, by the computer, an active window in the received screenshot, based on the screen location of the HID input;
program instructions to extract, by the computer, from the screenshot, the identified active window;
program instructions to determine, by the computer, a textual title of the active window; and
program instructions to store one or more electronic records, by the computer, comprising the extracted active window, the textual title of the active window, and the user identifier to a data store.

13. A computer system for auditing activity of a user on a user computing device, the computer system comprising:
one or more computer processors;
one or more computer-readable storage media;
program instructions stored on the computer-readable storage media for execution by at least one of the one or more processors, the program instructions comprising:
program instructions to receive, by a computer, a screenshot of a display device of the user computing device when the user computing device receives an input in a graphical user interface (GUI) from a human interface device (HID), and a screen location of the HID input, and a user identifier;
program instructions to identify, by the computer, an active window in the received screenshot, based on the screen location of the HID input;
program instructions to extract, by the computer, from the screenshot, the identified active window;
program instructions to determine, by the computer, a textual title of the active window; and
program instructions to store one or more electronic records, by the computer, comprising the extracted active window, the textual title of the active window, and the user identifier to a data store.

14. A computer system according to claim 13, wherein program instructions to identify the active window comprises:
program instructions to locate edges of one or more rectangles present in the received screenshot;
program instructions to identify one or more rectangles corresponding to the located edges;
program instructions to detect one or more windows corresponding to the identified rectangles; and
program instructions to identify the active window based on the screen location of the HID input within the detected one or more windows.

15. A computer system according to claim 13, wherein program instructions to determine the textual title of the active window comprises:
program instructions to recognize characters in a general region of a title bar of the active window using an object character recognition (OCR) technique; and
program instructions to extract the characters to develop the textual title of the active window.

16. A computer system according to claim 13,
wherein the program instructions to receive a screenshot of a display device further comprises program instructions to receive one or more of: a device identifier, a network identifier, an active user program identifier, raw HID inputs, and a date/time stamp; and
wherein the program instructions to store one or more electronic records further comprises program instructions to store one or more of: the device identifier, the network identifier, the active user program identifier, the raw HID inputs, and the date/time stamp.

17. A computer system according to claim 13, furthering comprising:
program instructions to replace the textual title of the active window with an internal dictionary key.

18. A computer system according to claim 13, further comprising:
program instructions to retrieve the extracted active window, the textual title of the active window and the user identifier from the data store; and
program instructions to display the extracted active window, the textual title of the active window and the user identifier on a GUI display of the computer.

19. A computer system according to claim 13, further comprising:
program instructions to load, by the computer, the one or more electronic records; and
program instruction to display, by the computer on a display device of the computer, the loaded one or more electronic records including one or more of:
the active window;
the textual title of the active window; and
the user identifier of the active window.

20. A computer system according to claim 13, further comprising:
program instructions to search, by the computer, an index of the one or more electronic records based on a query;
program instructions to rank results of the search; and
program instructions to display the results according to the rank.
